(19) United States
(12) Patent Application Publication
(10) Pub. No.: US 2013/0197710 A1
(43) Pub. Date: Aug. 1, 2013

(54) DISPATCH CONTROLLER FOR A DISTRIBUTED ELECTRICAL POWER SYSTEM

(71) Applicant: Lars Henrik Hansen, Roskilde (DK)

(72) Inventor: Lars Henrik Hansen, Roskilde (DK)

(73) Assignee: DONG ENERGY A/S, Fredericia (DK)

(21) Appl. No.: 13/642,879

(22) PCT Filed: Apr. 20, 2011
(86) PCT No.: PCT/EP2011/056328

§ 371 Date: Feb. 1, 2013

(30) Foreign Application Priority Data
Apr. 26, 2010 (DK) PA 2010 70169

(51) Int. Cl. H02J 3/38

(52) U.S. Cl. CPC H02J 3/382
USPC 700/297

(57) ABSTRACT

The present invention relates to a distributed electrical power system comprising a plurality of rechargeable power units such as electrical vehicles coupled to a common electrical power grid at remote locations. A dispatch controller is configured for controlling the supply of electrical power to the plurality of rechargeable power units in accordance with computed charge priorities.

The present invention relates to a distributed electrical power system comprising a plurality of rechargeable power units such as electrical vehicles coupled to a common electrical power grid at remote locations. A dispatch controller is configured for controlling the supply of electrical power to the plurality of rechargeable power units in accordance with computed charge priorities.

### BACKGROUND OF THE INVENTION

US 2009/0210357 A1 discloses methods and systems for controlling the charging of on-board energy storage systems of a plurality of plug-in electrical vehicles using a remote control center. Charge authorizations are transmitted to individual electrical vehicles by the remote control center through a data communication interface. User profiles associated with individual electrical vehicles facilitate convenient charging of the vehicles and may comprise information related to plug-in vehicle efficiency, charging schedules and preferred charging times of the user.

US 2008/0039979 A1 discloses methods and systems for a power aggregation system. A service establishes individual Internet connections to numerous electric resources intermittently connected to the power grid. The service optimizes power flows to suit the needs of each resource owner. The service is intended to bring vast numbers of electric vehicle batteries online as a new dynamically aggregated power resource for the power grid.

However, there is a need in the art for methods and systems providing an improved degree of flexibility and control over exactly when charging power is supplied to individual rechargeable power units or resources such as electrical vehicles coupled to a common electrical power grid. The present distributed electrical power system and control methods therefore allow electrical energy production to be in dispatched time, for example through a day, in a flexible manner without sacrificing the end-user's need to have his or hers rechargeable power unit, such as a rechargeable battery, rendered in operational condition in accordance with an end-user agreement when needed. Accordingly, the present invention may be applied to lower time variations of electrical power drawn by the plurality of rechargeable power units or resources coupled to a common power grid. The reduced electrical power fluctuations over time allow power plants producing the required electrical power to run with a more constant load for the benefit of improved power generation efficiency. At the same time the flexibility offered by the present distributed electrical power system and control methods thereof can be utilized to minimize peak loads which reduce the need for power grid reinforcement in order to handle the highest expected load.

Another advantage of the present distributed electrical power system and control methods is that electrical power consumption of the plurality of rechargeable power units or resources can be dispatched to times of the day where the price for available electrical power is at minimum and/or production of electrical power from renewable energy sources such as solar panels, wind-mil plants etc, is at maximum. Thus, lowering the emission of CO₂ and other green-house gasses in connection with electrical power production.

### SUMMARY OF INVENTION

According to a first aspect of the invention, there is provided a distributed electrical power system comprising a plurality of rechargeable power units coupled to a common electrical power grid at remote locations. A dispatch controller is configured to set a total charging power to the plurality of rechargeable power units based on a set-point power from an energy aggregator. The dispatch controller being configured to:
acquiring charge state data from the plurality of individual rechargeable power units indicating their respective current states of charge through a data communication link,
determine a target state of charge at a target time for each of the plurality of rechargeable power units based on an end-user agreement associated with an individual or a set of rechargeable power units,
determining charging current characteristics of each of the plurality of rechargeable power units,
compute a charge priority for each rechargeable power unit indicative of an amount of time required to reach the target state of charge based on the current state of charge, the target state of charge, the target time and the charging current characteristics of the rechargeable power unit,
determine a charging sequence or order of supplying charging power to the plurality of rechargeable power units based on computed charge priorities.

In the present specification and claims the target state of charge of a rechargeable power unit is also referred to as the Contract Of State Of Charge or COSOC and the current state of charge referred to as the State Of Charge or SOC. The target state of charge represents a minimum charge requirement that must be complied with at the target time. The COSOC and SOC of a particular rechargeable power unit are preferably expressed relative to a maximum energy storage capacity of the rechargeable power unit for example as respective percentages of the maximum energy storage capacity. The target time and the COSOC are linked for a particular rechargeable power unit in that the target time indicates the time of the day at which the target state of charge must be available to comply with the end-user agreement. For example, a lease firm may have contractual obligation to an end-user of an electrical vehicle to deliver a target state of charge of 60% of the maximum energy storage capacity of the electrical vehicle at 7 AM. Thus, ensuring the electrical vehicle is sufficiently charged to make the end-user capable of making his or hers commute forth and back to work in the electrical vehicle at the beginning of a working day. The rechargeable power unit may be owned, rented, leased or otherwise at the end-user's disposal.

It is understood that the COSOCs and associated target times may vary considerably between the plurality of rechargeable power units controlled by the present dispatch controller depending on the type of rechargeable power unit and/or needs of a particular end-user. These factors may be governed by appropriate terms and conditions of the end-user agreement in question.

This end-user agreement is associated with an individual or a set of rechargeable power units to set a target state of charge and target time for each rechargeable power unit controlled by the dispatch controller. Each rechargeable power unit may be governed by an individual end-user as regards the target state of charge and the target time. Alternatively, a smaller or larger group of rechargeable power units may be at the disposal of respective end-user's on identical terms and conditions, including the COSOCs and target times, by virtue of an end-user agreement covering the entire group or fleet of rechargeable power units. The end-user agreement may accordingly be made directly between a natural person, typically the end-user of the rechargeable power unit, and an electrical utility company or supplier responsible for supplying the charging power through the power grid. In other arrangements, the end-user agreement may be made between an intermediary firm or legal person such as a lease firm of electrical utility devices and the end-user. The intermediary firm may in turn have an appropriate contractual arrangement with the electrical utility company responsible for supplying the charging power to the end-users. The dispatch controller and its method of operation may in practice be controlled by either of the energy aggregator, electrical utility company and the intermediary firm.

The energy aggregator supplying the set-point power to the dispatch controller may comprise a power utility control center, a fleet operator, a distribution system operator or any other appropriate entity with authorization to control the set-point power. The power utility control center and the fleet operator may be separate corporations or the same corporation.

The dispatch controller may be coupled to each of the rechargeable power units through any standardized or proprietary wireless or wired data communication link or network and communication protocol. In one embodiment, the communication link comprises a LAN or WLAN network and each rechargeable power unit transmits its current state of charge according to the TCP/IP protocol through the LAN or WLAN network. In other embodiments, the communication link is integrated with the common electrical power grid through power line communication carrying the charge state data, such as the current state of charge of the rechargeable power unit, through power line conductors of the electrical power grid. The latter embodiment is highly useful for mobile rechargeable power units like electrical vehicles where it may be desirable to connect to, and charge from, the common electrical power grid and the data communication link at many different remote locations.

The dispatch controller is preferably implemented as a computer program or application running on central computer of a central power plant surveillance system. The central computer may comprise a PC based or UNIX based server operatively coupled to the communication link to allow the charge state data from the plurality of individual rechargeable power units to be acquired and appropriately processed by the dispatch controller.

The remote locations where the plurality of rechargeable power units is situated may be distributed across a relatively limited geographical area such as a town neighbourhood or a small town or across much larger areas such as a large city, province or state. Some or all of the remote locations may be situated at households within the geographical area in question. The rechargeable power unit at the household's disposal may be permanently installed there or mobile depending on the particular type of rechargeable power unit. The wide-spread availability and speed of modern data communication networks make the dispatch controller capable of instant communication with a very large number of rechargeable power units spread out over a wide geographical area.

The target time and the charging current characteristics of each of the rechargeable power units may be acquired by the dispatch controller from an integral customer or remote customer database holding the relevant information. Each rechargeable power unit may have a unique ID associated therewith from which the relevant target time and charging current characteristics can be retrieved by the dispatch controller from the customer database. In addition, the customer database may hold address information and identity information of the end-user of each rechargeable power unit.

According to one advantageous embodiment of the present invention, the end-user is capable of modifying an already existing setting of the target of state of charge and/or the target time in the customer database to adapt the setting of these parameters to changing needs of the end-user. A request to change current settings of the target of state of charge and/or a target time may be transmitted from a rechargeable power unit via the data communication link to the dispatch controller. Preferably, the dispatch controller is configured to check that the requested change of the parameter settings meet certain technical or contractual constraints such as constraints governed by the end-user agreement before effecting the requested change. The change of the existing setting of the target of state of charge and/or the target time may be effected by modifying the appropriate database fields of the integral customer or remote customer database holding the relevant information. This embodiment gives the end-user considerable flexibility in controlling for example the setting of the target time so it can be adapted to changes in the life-style or habits of the end-user or simply tailored to an isolated event deviating from otherwise well-established daily habits.

Based on the knowledge about the target state of charge at the target time, the current state of charge and the charging current characteristics for each of the plurality of rechargeable power units, the dispatch controller is capable of assigning an appropriate priority for the charging of each of rechargeable power unit. By computing the charge priority the dispatch controller ensures that the available total charging power, as defined or set by the set-point power is distributed to the particular subset of the rechargeable power units that posses the most urgent demand for charging power in order to timely reach their respective target states of charge.

From a perspective of the energy aggregator, the dispatch controller may be viewed as a mechanism or tool that enables electrical power to the rechargeable power units to be delivered at desirable or advantageous time periods that comply with complex power systems constraints of technical, economical or environmental nature. The energy aggregator may be adapted or programmed to control the set-point power to the dispatch controller to be so high that it allows all the rechargeable power units to charge at respective maximum allowable charging powers or currents when electrical power is known to be cheap, environmentally friendly or both. On the other hand, if electrical power is determined to be expensive, accompanied by high CO₂ emission, or both, the dispatch controller may be controlled in a manner where the supply of charging power is deferred to those rechargeable power units that have ample time to reach their respective target states of charge. Since the latter rechargeable power units automatically will be placed at the end of the determined charging order or sequence they may be cut off from charging power if or when the set-point power is much less than the total charging power required for charging all rechargeable power units with their respective maximum allowable charging power.

Because the dispatch controller has knowledge of the target time at which the target state must be reached it can determine how close or far in time any particular rechargeable power unit is from reaching its target state of charge based on the individually known charging current characteristics. The most significant charging current characteristic of a rechargeable power unit will often be its maximum allowable charging current. At many instances, ample time to reach the respective target states of charge may be available for a certain smaller or larger subset or group of the plurality of rechargeable power units.

The sequence or order of supplying charging power to the plurality of rechargeable power units computed by the dispatch controller based on the computed charge priorities is preferably utilized such that the charging of rechargeable power units with small charge priorities are placed at the end of the sequence and rechargeable power units with large charge priorities are placed at the beginning of the sequence. Preferably, the sequence strictly follows magnitudes of computed charge priority figures such that the rechargeable power unit with the largest charge priority value in placed first in the sequence and the rechargeable power unit with the smallest charge priority value placed last and the residual rechargeable power units in-between according to their charge priority magnitudes.

The energy aggregator may be adapted to control the actual setting of the set-point power supplied to the dispatch controller in dependence of electrical power production projections or forecasts. It may for example be known that a windmill park, hydro-electric plant or other sustainable power plant will begin to produce a certain large quantity of clean or cheap electrical power at a certain projected point in time in the future. Based on this information about future availability of electrical power, the energy aggregator may set a relatively low set-point power until the projected point in time and increase the set-point power thereafter. Until the projected point in time is reached, the dispatch controller may be adapted to continuously identity and charge that subset of the plurality of rechargeable power units that possess the highest charge priorities allowing these to be charged to their respective target states of charge at the respective target times by the available quantity of total electrical power. Charging of the residual rechargeable power units, with the smallest charge priorities, of the plurality of rechargeable power units may be deferred by dispatch controller until after the projected point in time where electrical power may be cheap and/or sustainable. Thus, minimizing overall costs or CO₂ emission of rendering all rechargeable power units in their target states of charge in due time according to the respective end-user agreements.

The plurality of rechargeable power units coupled to the common electrical power grid may comprise two or more individual rechargeable power units such as more than 100 or more than 10000 or even more than 100.000 individual rechargeable power units. A rechargeable power unit may be owned, leased or rented by a natural person and placed at private premises of that person or the rechargeable power unit may be owned, leased or rented by a corporation or firm. An individual rechargeable power unit of a private household may have an energy storage capacity between 1 kWh and 100 kWh such as between 5 kWh and 25 kWh. A rechargeable battery pack of a fully electrical car is typically capable of holding between 20 and 25 kWh of electrical energy.

From the foregoing it follows that the present distributed electrical power system allows electrical power or energy production to be displaced in time in a flexible manner without sacrificing the end-users' need to have their respective rechargeable power units rendered in fully operational condition, as set by the target state of charge, when needed. Accordingly, the present invention may be applied to lower time variations in electrical power drawn by the plurality of rechargeable power units or resources coupled to a common electrical power grid. These reduced time variations allow electrical power plants producing the electrical power to run with a more optimal load for the benefit of improved power generation efficiency. At the same time, peak loads on the common electrical power grid are reduced in magnitude which in turn beneficially reduces the need for oversizing electrical wires and other components of the common electrical power grid or network.

Another advantage of the present distributed electrical power is that the energy aggregator, through the control of the set-point power to the dispatch controller, can displace electrical power consumption of the plurality of rechargeable power units or resources to times where production of electrical power by renewable energy sources such as solar panels, wind-mil plants etc, is at maximum (thus lowering the emission of CO₂ and other green-house gasses) or the price of electrical power is minimal which incidents may or may not coincide.

According to a preferred embodiment of the invention, the dispatch controller is configured to:
determine a maximum allowable charging current of each of the rechargeable power units,
estimating a minimum time interval required for reaching the target state of charge for each of the plurality of rechargeable power units,
organizing the charging sequence according to the determined minimum time intervals such that the rechargeable power unit with the shortest minimum time interval is placed first in the charging sequence and the rechargeable power unit with the longest minimum time interval placed last. In this embodiment all rechargeable power units are ordered in the charging sequence according to the determined minimum time intervals. The minimum time interval of a particular rechargeable power unit is computed on the basis of the current state of charge (SOC), the target state of charge and the maximum allowable charging current. Charging current compliance with the maximum allowable charging current is often enforced by a steerable charge control system of the rechargeable power unit setting a magnitude of the charging current to the rechargeable power unit. The steerable charge control system may form part of a battery management system which may be responsible for maintaining safe operating conditions of the rechargeable power unit during charging.

The minimum time interval of a rechargeable power unit is accordingly a very useful expression of how far in time the rechargeable power unit in question is from reaching its target state of charge in case the maximum possible charging current is supplied constantly. It follows that the minimum time intervals are useful as charge priority indicators since inspection of the minimum time intervals allows the dispatch controller to determine which ones of the plurality of rechargeable power units have the most urgent demand or need for charging power by comparing the minimum time intervals to the actual time left to the target time for any particular rechargeable power unit.

In another embodiment of the present distributed electrical power system the dispatch controller is configured to compute or determine numerical priority indicator values so as to conveniently rank the plurality of rechargeable power units according to their need for charging power. The dispatch controller being configured to:
determine a priority indicator, a, for each rechargeable power unit by computing an average charging current required to reach the target state of charge at the target time and divide the computed average charging current with a maximum allowable charging current of the rechargeable power unit. The dispatch controller supplying charging power or current to the plurality of rechargeable power units according to the order indicated by computed values of the priority indicators, α.

The dispatch controller is adapted to set the total charging power to the plurality of rechargeable power units substantially equal to the set-point power indicated by the energy aggregator. In one embodiment this is achieved by configuring the dispatch controller to supply charging power to only a subset of the power consuming with the highest charge priorities for a set or predetermined time period. The residual rechargeable power units with lower charge priorities are left without any supply of charging power during the predetermined time period. According to this embodiment, the dispatch controller is configured to selecting a subset of rechargeable power units with highest priorities such that a sum of the respective maximum allowable charging powers of the subset of rechargeable power units matches the set-point power. Thereafter, each rechargeable power unit of the subset is charged with its maximum allowable charging power.

In this embodiment, the dispatch controller may start out by identifying the rechargeable power unit with the highest priority, determine the maximum allowable charging power of the rechargeable power unit with the highest priority and subsequently proceeding to the rechargeable power unit with the second highest priority, determine the maximum allowable charging power of latter rechargeable power unit, add the latter maximum allowable charging power to the current total allowable charging power and so on. By adding rechargeable power units to the subset according to the determined charging order until the total or aggregated maximum allowable charging power of the selected subset about equals the set-point power, the composition of the subset can be determined in an efficient straight-forward manner by the dispatch controller. In final step, each rechargeable power unit of the subset is charged with its maximum allowable charging power. Since rechargeable power units are added to the subset in the determined charging order or sequence, the dispatch controller ensures that the rechargeable power units with highest priorities, or largest priority indicators, are appropriately selected. In other embodiments, all of the rechargeable power units may be charged simultaneously but the determined charge priorities utilized to set the charging current to rechargeable power units with high priority to a larger value than those with low priority. For example may a certain portion of the rechargeable power units with high charge priorities be charged with their respective maximum allowable charging currents while rechargeable power units with low priority may be charged with charging currents that are 10% or 20% of the respective maximum allowable charging currents.

In yet an another embodiment, the charging power to each rechargeable power unit is set in direct proportion to the magnitude of the priority indicator of the power consuming such that a rechargeable power unit with a priority indicator of 0.99 is charged with a charging power equal to 0.99 times the maximum allowable charging power. A rechargeable power unit with a priority indicator of magnitude 0.5 is charged with a charging power equal to 0.5 times the maximum allowable charging power and so on.

In yet another embodiment of the present distributed electrical power system the dispatch controller is configured to re-compute or revise charge priorities between the plurality of rechargeable power units over time. The dispatch controller is configured to re-compute the charge priority for each rechargeable power unit at regular or non-regular time intervals such as time intervals smaller than 30 minutes, more preferably smaller than 15 minutes, or even more preferably smaller than 5 minutes; The dispatch controller sets the charging the plurality of rechargeable power units in accordance with the re-computed sequence or order. In this embodiment, a dynamic or adaptive mechanism is created for continuously evaluating the computed charge priorities between the plurality of rechargeable power units. In effect, charging power to a certain first rechargeable power unit which at a first instant in time had a high charge priority, because the first rechargeable power unit was far away from its target state of charge, may after a certain period of charging, for example with its maximum allowable charging current, reach a current state of charge much closer to the target state of charge than other rechargeable power units, in particular those other rechargeable power units with low charge priorities at said first instant in time. This will cause a re-computed charge priority of the first rechargeable power unit to decrease while other charge priorities will increase. This may eventually lead to a disruption of charging power to the first rechargeable power unit before it has reached the target state of charge. In this manner, the charging sequence or order of the plurality of rechargeable power units is dynamically changed at the regular or non-regular time intervals. This dynamic swapping of the charging order of the rechargeable power units ensures that a high charge priority eventually will be assigned to any rechargeable power unit far away in time from its target state of charge.

According to a preferred embodiment of the invention, the target state of charge of each of the rechargeable power units is set to a value larger than 60% of a maximum charge storage capacity of the rechargeable power unit. In a variant of this embodiment, the target state of charge of each of the rechargeable power units is set to a value between 65% and 95%, more preferably between 75% and 90%, of the maximum charge storage capacity of the rechargeable power unit. By setting the target state of charge of each rechargeable power unit to a value well-below the maximum charge storage capacity of the unit, a considerable flexibility in energy storage capacity of the distributed electrical power system is achieved. Under certain conditions, the rechargeable power units may be rendered in, or charged to, respective current states of charge significantly above the respective target states of charge. These conditions may comprise time periods where production of electrical power from renewable energy sources is at maximum (thus lowering the emission of CO₂ and other green-house gasses) and/or the price of electrical power is minimal. The overcharged (relative to the target state of charge) condition of the rechargeable power units provides a beneficial energy buffer or reservoir which may be exploited by the dispatch controller to avoid, or at least minimize, the supply charging power to the plurality of rechargeable power units during peak-load hours or times where the price of electrical power is high.

A rechargeable power unit may comprise any type of rechargeable energy reservoir suitable for storage of the charging power in chemical or thermal form. The rechargeable power unit may accordingly comprise a super capacitor, rechargeable battery or battery pack. In other embodiments, the rechargeable power unit may store charging power in form of thermal power in a suitable fluid, gas or liquid and in yet other embodiments, the charging power may be stored in a pressurized gas. If the rechargeable power unit comprises a rechargeable battery or battery pack the latter may rely on various known types of battery technology such as lead-acid, nickel cadmium (NiCd), nickel metal hydride (NIMH), lithium ion (Li-ion), or lithium ion polymer (Li-ion polymer) or any combination of these battery types. One or more of the plurality of rechargeable power units may comprise an electrical vehicle such as plug-in hybrid electrical cars or plug-in fully electrical cars. In some embodiments of the plug-in hybrid electrical cars or fully electrical cars, the rechargeable battery pack may be releasably coupled to the electrical vehicle by suitable mechanical and electrical connector mechanism to allow rapid change of a depleted or discharged rechargeable battery pack at battery change stations.

Each of the plurality of rechargeable power units may comprise a steerable charge control system capable of controlling charging power to the rechargeable power unit in accordance with a charge control input supplied by the dispatch controller through the data communication link. In this embodiment, the steerable charge control system is capable of reading commands or instructions through the charge control input and responding thereto. The steerable charge control system preferably comprises a suitably programmed microprocessor and a bi-directional control port or interface compliant with the selected communication protocol on the data communication link. This allows the steerable charge control system to receive and comply with charge commands or instructions transmitted by the dispatch controller. At the same time, the steerable charge control system may utilize the bi-directional control port to transmit the current state of charge of the rechargeable power unit to the dispatch controller on demand or voluntarily.

As previously mentioned, the steerable charge control system may form part of the battery management system of the rechargeable power unit. The battery management system is responsible for maintaining safe operating conditions of the rechargeable power unit such as a rechargeable battery pack during charging to avoid overheating or similar potentially destructive operating conditions.

In another embodiment, one or more of the rechargeable power units are coupled to an intelligent intermediate charging pylon or stand which comprises the steerable charge control system. In this embodiment, the charging power to the rechargeable power unit is controlled in on/off fashion by the control logic inside the charging pylon or stand.

The steerable charge control system of each rechargeable power unit may advantageously be adapted to transmit the maximum allowable charging power of the rechargeable power unit to the dispatch controller. In this way, a direct transmission of an important parameter of the charging current characteristics of the rechargeable power unit can be accomplished which minimizes the risk for acquiring erroneous parameter information from other possibly non-updated data sources regarding the maximum allowable charging power of a certain rechargeable power unit. The maximum allowable charging power may conveniently be transmitted to the dispatch controller through the above-described bi-directional control port coupled the data communication link. In the alternative, the maximum allowable charging power of the rechargeable power unit may be retrieved by the dispatch controller from a customer database operatively coupled to the dispatch controller and holding this and other relevant items of end-user information.

In one embodiment, the customer database comprises the target state of charge, the target time and the charging current characteristics of the rechargeable power unit for each of the plurality of rechargeable power units. Consequently, the charge priority of each rechargeable power unit may be computed by the dispatch controller in a manner where only the current state of charge need to be transmitted by each of the rechargeable power units.

The customer database preferably comprises various information items associated with each rechargeable power unit such as one or more end-user information items selected from a group of {end-user identity and address, preferred charging times, historic charging times, power utility supplier identifier, rechargeable power unit identifier}.

According to one embodiment of the present distributed electrical power system, a back-up or fail-safe feature is added to the rechargeable power units to ensure that each rechargeable power unit reaches its target state of charge at the target time even during data communication interruptions or programs errors in the dispatch controller. According to this embodiment, the steerable charge control system of each rechargeable power unit is adapted to:

compute a minimum time period required to reach the target state of charge at the target time,

override the charge control input and set a predetermined charging power to the rechargeable power unit if the computed minimum time period exceeds actual time left to the target time. The minimum time period can be computed by a suitably programmed microprocessor controlling the steerable charge control system based on information about the current state of charge, the target state of charge, the target time and the maximum allowable charging current. The target time, the target state of charge and the maximum allowable charging current of the rechargeable power unit may have been programmed into a suitable memory address or area of the steerable charge control system on a prior occasion for example in connection with the execution of the end-user agreement.

An alternative embodiment comprising the back-up or fail-safe feature, the steerable charge control system is adapted to:
compute a minimum time period required to reach the target state of charge at the target time,
prepare and transmit an electronic alert message, such as e-mail, MMS or SMS, to an end-user if the computed minimum time period exceeds actual time left to the target time. If the computed minimum time period exceeds the actual or real time left to the target time, the steerable charge control system can reasonably conclude that a fault has occurred in the charging process of the rechargeable power unit in question. It will not be possible to reach the target state of charge within the actual period of time left to the target time. In response, the steerable charge control system is able to mitigate adverse effects of the fault by notification of the end-user through the electronic alert message. The electronic alert message may at least allow the end-user to take appropriate corrective action such a postponing or rescheduling a planned car trip or finding an alternative operational energy source.

The steerable charge control system of the rechargeable power unit comprises a two quadrant or a four quadrant power converter operatively coupled to the common electrical power grid so as to supply charging power from the common electrical power grid to the rechargeable power unit or supply electrical power from the rechargeable power unit to the common electrical power grid. The two quadrant power converter converts the AC mains voltage (220/240/380 V or 110 V) to an appropriate DC voltage and charging current for the rechargeable power unit. The two quadrant power converter accordingly allows transmission of charging power in a direction from the common electrical power grid to the rechargeable power unit to allow charging the latter. Other embodiments of the steerable charge control system comprise the four quadrant power converter for increased energy storage flexibility. The four quadrant power converter allows bi-directional transmission of electrical power, i.e. from the common electrical power grid to the rechargeable power unit and vice versa. When the four quadrant power converter is operational to convert DC voltage and current from the rechargeable power unit, such a rechargeable battery pack, to the mains AC voltage of the common electrical power grid, it is often referred to as an “inverter”.

In a particular advantageous embodiment of the present distributed electrical power system wherein at least a first subset of rechargeable power units comprises respective four quadrant power converters, the dispatch controller is configured to:
identify a first subset of rechargeable power units having respective current states of charge above the target states of charge,
identify a second subset of rechargeable power units having respective current states of charge below the target states of charge,
command, through the steerable charge control systems, the first subset of rechargeable power units to supply a predetermined amount of electrical power to the common electrical power grid,
command, through the steerable charge control systems, the second subset of rechargeable power units to partly of entirely consume the predetermined amount of electrical power from the common electrical power grid. This embodiment of the present distributed electrical power system provides an increased degree of flexibility in how and when electrical power is delivered through the dispatch controller to ensure the plurality of rechargeable power units are delivered in their respective target states of charge. The first subset of rechargeable power units comprises overcharged rechargeable power units (relative to the respective target states of charge) and provides the previously-mentioned beneficial energy buffer or reservoir. Due to the four quadrant power converters, surplus energy in these overcharged rechargeable power units may be transferred to the common power grid and further to the second subset of rechargeable power units that need charging power to reach their respective target states of charge under control of the dispatch controller. Accordingly, the surplus electrical energy stored in the first subset of rechargeable power units, and possibly produced at low cost, environmentally friendly or both, can be exploited to charge the second subset of rechargeable power units which is undercharged. At the same time, the transmission of charging power from the first to the second subsets of rechargeable power units decreases the total amount of charging power to be produced by the power plants and conveyed through the power transmission grid.

In certain embodiments of the present invention, one or more of the rechargeable power units may comprise an aggregated pool of separate and proximately located rechargeable power units such as a plurality of individual battery packs for electrical vehicles at a battery change station. In another embodiment the aggregated pool of separate and proximately located rechargeable power units may comprise a plurality of electrical cars placed on a parking lot. The parking lot operator may offer to charge the customers plurality of electrical cars during parking in accordance with terms of an end-user agreement between the parking lot operator and the energy aggregator. A steerable charge control system is preferably coupled to the plurality of individual rechargeable battery packs or electrical vehicles to individually controlling charging thereof while treating these as a single rechargeable energy reservoir or resource when viewed from the dispatch controller.

In a second aspect of the present invention, there is provided a method of controlling supply of electrical power to a plurality of rechargeable power units coupled to a common electrical power grid at remote locations. The method comprises steps of:

a) receiving a set-point power from an energy aggregator,
b) acquiring charge state data from the plurality of rechargeable power units about their respective current states of charge through a data communication link,
c) determining a target state of charge at a target time for each of the plurality rechargeable power units based on an end-user agreement associated with an individual or a set of rechargeable power units,
d) determining charging current characteristics of each of the plurality of rechargeable power units,
e) computing a charge priority for each rechargeable power unit indicative of the amount of time required to reach the target state of charge based on the current state of charge, the target state of charge, the target time and the charging current characteristics of the rechargeable power unit,
f) determining a sequence or order of supplying charging power to the plurality of rechargeable power units based on computed charge priorities,
g) control charging of the plurality of rechargeable power units in accordance with the determined sequence or order.

The above-specified method is preferably implemented by a computer-implemented dispatch controller residing within a distributed electrical power system and programmed to execute the method steps a)-g) under control of a suitable set of program instructions. The previously provided explanations about the meaning, functionality and advantages of the individual features of method steps a)-g) in connection with the same features under the first aspect of the present invention, i.e. the distributed electrical power system, apply equally to the present method of controlling supply of electrical power to a plurality of rechargeable power units.

According to one embodiment of the method, the dispatch controller is configured to:
determine a maximum allowable charging current of each of the rechargeable power units,
estimating a minimum time interval required for reaching the target state of charge for each of the plurality of rechargeable power units,
organizing the charging sequence according to the determined minimum time intervals such that the rechargeable power unit with the shortest minimum time interval is placed first in the charging sequence and the rechargeable power unit with the longest minimum time interval is placed last.

The dispatch controller may be configured to compute or determine numerical priority indicator values so as to conveniently rank the plurality of rechargeable power units according to their need for charging power by inspection of a single number for each rechargeable power unit. According to this embodiment, the dispatch controller determines a priority indicator (a) for each rechargeable power unit by computing an average charging current required for the rechargeable power unit to reach the target state of charge at the target time. The dispatch controller thereafter divides the computed average charging current value with a maximum allowable charging current of the rechargeable power unit, and
supplies charging current to the plurality of rechargeable power units in accordance with the determined priority indicators such that rechargeable power units with large priority indicators are charged before rechargeable power units with small priority indicators. Naturally, a subset of the rechargeable power units with large priority indicators, i.e. above a certain threshold value may be charged simultaneously. For example, the dispatch controller may be adapted to charge all rechargeable power units with a priority indicator larger than 0.5 or 0.75 etc. The available total charging power as indicated by set-point power may thereafter be distributed between the subset of rechargeable power units according to a predetermined distribution key.

In an alternative embodiment, the dispatch controller is configured to:
selecting a subset of rechargeable power units with highest charge priorities such that a sum of the respective maximum allowable charging powers of the subset of rechargeable power units matches the set-point power,
simultaneously charging each rechargeable power unit of the subset with its maximum allowable charging power. In this manner, the composition (incl. size) of the subset of rechargeable power units is adapted to match the available total charging power as indicated by set-point power.

According to a preferred embodiment of the present methodology, the charge priority according to step e) of above-referenced method of controlling supply of electrical power to a plurality of rechargeable power units is recomputed at regular or non-regular time intervals such as time intervals smaller than 30 minutes, more preferably smaller than 15 minutes, or even more preferably smaller than 5 minutes. The charging of the plurality of rechargeable power units is thereafter effected in accordance with the re-computed sequence or order.

According to an embodiment of the present methodology, the target state of charge of each of the rechargeable power units is set to a value of at least 60%, such as between 65% and 95%, or more preferably between 75% and 90%, of a maximum charge storage capacity of the rechargeable power unit. As previously-mentioned there are advantages of setting the target state of charge of each of the rechargeable power units to a value less than 100%, such as less than 90% or 75%, of the maximum charge storage capacity of the rechargeable power unit.

In one embodiment of the present methodology wherein each of the plurality of rechargeable power units comprises a steerable charge control system, the steerable charge control system supplies charging power to the rechargeable power unit in accordance with a charge control input supplied by the dispatch controller through the data communication link.

The dispatch controller may be computer-implemented and comprise a software programmable microprocessor such as a programmable fixed-point or floating point Digital Signal Processor. The computer-implemented dispatch controller may comprise a program memory loaded with a set of program instructions configured or adapted to implement the above-described steps executed by dispatch controller in accordance with the second aspect of invention. The set of program instructions may comprise executable microprocessor code or instructions such as executable instructions for a Digital Signal Processor.

Alternatively, the dispatch controller may comprise dedicated or hard-wired arithmetic and logic circuitry and/or programmable logic arrays adapted to executed the above-described method steps of the dispatch controller in accordance with the second aspect of invention. In other embodiments, the dispatch controller may be implemented as a hybrid of dedicated or hard-wired arithmetic and logic circuitry for executing certain method steps and software program instructions for other steps.

According to a third aspect of the invention, a data carrier comprises the set of program instructions configured or adapted to implement the above-described steps executed by dispatch controller in accordance with the second aspect of invention. The set of program instructions may be provided in executable format or source code format that needs compilation. The data carrier may be computer readable carrier such as a magnetic or optical disc or drive, an EEPROM or EPROM chip, a flash-memory assembly or stick, or other any other appropriate type of non-volatile electronic memory assembly.

### BRIEF DESCRIPTION OF THE DRAWINGS

A preferred embodiment of the invention will be described in additional detail in connection with the append drawings in which:

FIG. 1 is a schematic drawing of a distributed electrical power system according to a preferred embodiment of the invention,

FIG. 2 is a flowchart of the operation of a dispatch controller of the distributed electrical power system depicted on FIG. 1; and

FIG. 3 is a detailed flowchart of a selection routine executed by the dispatch controller to select a subset of rechargeable power units eligible for charging.

### DESCRIPTION OF PREFERRED EMBODIMENTS

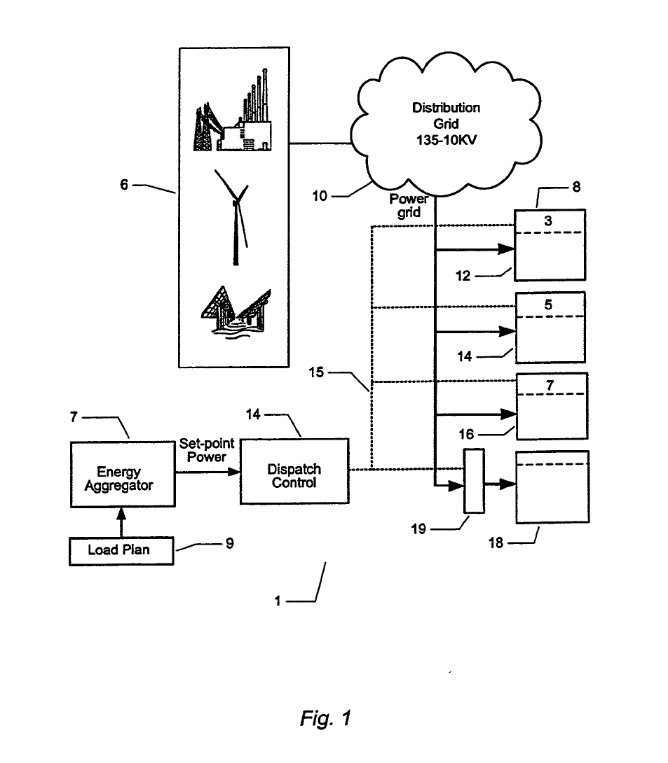

FIG. 1 is a simplified schematic drawing of a distributed electrical power system 1 according to a preferred embodiment of the invention. The distributed electrical power system 1 comprises four rechargeable power units 12, 14, 16, 18 in the form of electrical cars coupled to a common electrical power grid 10 at remote locations. A limited number of rechargeable power units have been selected for simplicity in the present exemplary embodiment and it is understood that other embodiments may comprise a substantial larger number of rechargeable power units such as between 100 and 10000 units. The four rechargeable power units 12, 14, 16, 18 may as mentioned above comprise fully electrical cars or hybrid-electrical cars comprising respective rechargeable battery packs for energy storage.

A computer-implemented dispatch controller 14 is operatively coupled to the each of the four electrical cars 12, 14, 16, 18 via a bi-directional data communication link 15 which may comprise a WLAN link. Each of the three rechargeable power units 12, 14, 16 comprises a steerable charge control system 3, 5, 7, respectively, capable of controlling the supply of charging power or current to the rechargeable power unit in question in accordance with a charge control input supplied by the dispatch controller 14 through the WLAN link 15. The steerable charge control system also comprises an interface port for receipt of the charge control input supplied by the dispatch controller 14 and transmission of the charge state data to the dispatch controller 14. Other relevant data concerning a current state or operation of the electrical car may also be transmitted to the dispatch controller 14.

The electrical car 18 is charged through an intermediary post or stand 19 which is coupled to the WLAN data communication link 15 and the common electrical power grid 10 or distribution grid.

Each of the steerable charge control system 3, 5, 7 preferably comprises a suitably programmed microprocessor and a four quadrant power converter controlled by the microprocessor. The four quadrant power converter is coupled in-between the distribution grid 10 and the rechargeable battery pack of the electrical car and dynamically sets the amount of charging power or current delivered to the battery pack to ensure safe operation conditions are adhered to.

Each of the steerable charge control systems 3, 5, 7 is adapted to transmit the maximum allowable charging power of the associated electrical car to the dispatch controller 14 through the WLAN link 15. These maximum allowable charging powers, which may be expressed in terms of equivalent maximum allowable charging currents, are generally of different magnitude but may be identical in certain situations for example where the electrical cars 12, 14, 16 are of the same make and model and/or if the electrical cars are equipped with the same type of rechargeable battery pack. In addition, each of the steerable charge control systems 3, 5, 7 is adapted to detect a current state of charge of the battery pack and subsequently transmit this to the dispatch controller 14. The current state of charge is preferably transmitted on interrogation by the dispatch controller 14 at regular time intervals for example every 15 minutes. The current state of charge may be monitored regularly by the microprocessor of the steerable charge control system and written to a suitable memory address from where the current state of charge may be read and transmitted to the dispatch controller 14 on request.

The dispatch controller 14 receives a set-point power from an energy aggregator 7 or distribution system operator responsible for producing electrical power through individual control of power plants of a power plant portfolio 6 according to a predetermined load plan 9. Produced electrical power is distributed through the distribution grid 10 to certain rechargeable power units which are controlled by the dispatch controller 14, such as the electrical cars 12, 14, 16, 18 and to other power consumers uncontrolled by the dispatch controller 14 as schematically indicated by the distribution grid cloud 10.

A total available charging power for distribution by the dispatch controller to the electrical cars 12, 14, 16, 18 is indicated by the set-point power applied to an input of the dispatch controller 14. The task of the dispatch controller 14 is accordingly to find a distribution of this total available charging power amongst the connected the electrical cars 12, 14, 16, 18 that will satisfy contractual obligations to deliver each of the end-user's electrical cars in the target state of charge at the target time. This is effected through the computation of priority indicators for the electrical cars 12, 14, 16, 18 indicating how far away in time each of the electrical cars is from reaching its target state of charge if the maximum allowable charging power is supplied to the electrical car in question. This amount of time is defined as a minimum time interval for each electrical car.

The computation of priority indicators by the dispatch controller 14 preferably begins with determining the current state of charge of each of the electrical cars 12, 14, 16, 18 by respective inquiries or requests to the steerable charge control systems 3, 5, 7 as explained above. The dispatch controller may have knowledge of the target state of charge and the target time for each of the electrical cars 12, 14, 16, 18 or it may receive these data from an integral or remote customer database (not shown) holding the relevant information. Each of the electrical cars 12, 14, 16, 18 has a unique ID associated therewith from which the relevant target state of charge, target time and possibly charging current characteristics can be retrieved. The customer database may hold address and identity details of the end-users of the electrical cars 12, 14, 16, 18.

The dispatch controller 14 preferably acquires the maximum allowable charging current for each of the electrical cars 12, 14, 16, 18 through the above-mentioned customer database or in the alternative through the steerable charge control systems 3, 5, 7 via WLAN link 15.

Once the dispatch controller 14 has determined the maximum allowable charging current, the target state of charge, the target time and the current state of charge of each of electrical cars 12, 14, 16, 18, an average charging current required to reach the target state of charge at the target time is computed. The dispatch controller 14 subsequently determines or computes a priority indicator (a) by dividing the computed average charging current with the known maximum allowable charging current for each of the electrical cars 12, 14, 16, 18. The priority indicators are consequently a computationally efficient and elegant way of expressing the relative charge priority between the electrical cars 12, 14, 16, 18 by numerical values. A charging sequence or order can accordingly be set directly according to the magnitudes of the computed priority indicators such that the electrical car (or other rechargeable power unit) with the highest priority indicator value, for example 1.0 or 0.95, is number 1 in the charge sequence and the electrical car with smallest priority indicator, for example 0.05 or 0.1, is last and so on.

From the above considerations, it follows that if the computed priority indicator is 1.0 for a certain rechargeable power unit, the dispatch controller 14 may conclude that the rechargeable power unit (e.g. electrical car) must constantly be charged at its maximum allowable charging current to reach its target state of charge at the target time. In this situation, the dispatch controller must ensure that this rechargeable power unit is charged instantly to comply with the relevant target state of charge. If the computed priority indicator is much smaller than 1.0 for example less than 0.5 or 0.3, the dispatch controller 14 can safely postpone the charging of that rechargeable power unit for example to a time where the priority indicator reaches a certain predetermined threshold value. Finally, if the computed priority indicator is larger than 1.0 it indicates that the rechargeable power unit will be unable to reach its target state of charge at the target time even if charged with its maximum allowable charging current. In the latter situation, the dispatch controller may initiate, control or execute certain advisory or alerting actions such as preparing and transmitting an electronic alert message, for example an e-mail, MMS or SMS, to the end-user of the electrical car in question. The electronic alert message may be directed to the end-users portable terminal (e.g. mobile phone) and/or directed to the electrical car in question. In the latter case, an in-car screen or display may be adapted to display the electronic alert message to the end-user.

In the present embodiment of the invention, the dispatch controller 14 selects a subset of electrical cars eligible for charging based on the total available charging power, as indicated by the set-point power, by incrementally adding new electrical cars to the subset. The selection of the subset involves summing the maximum allowable charging powers of the electrical cars starting out with the electrical car with the highest charge priority indicator. At each increment a summed maximum allowable charging power, representing the current subset of selected electrical cars, is compared to the total available charging power. If the summed maximum allowable charging power is smaller than the total available charging power, the maximum allowable charging power of the next electrical car in the computed priority sequence is added and so on. Once, the summed maximum allowable charging power of the selected subset exceeds the total available charging power, the addition of further electrical cars to the subset is cancelled. All electrical cars of the selected subset and subsequently charged at their respective maximum allowable charging powers and this charging state may continue for a certain period of time when a new or revised charging order is computed as explained below.

In the present embodiment of the invention, the dispatch controller is configured to re-compute the charge priority for each rechargeable power unit at regular time intervals such as every 15 minutes or less. Once, appropriate charge priorities are recomputed for the all the electrical cars, a new or revised charging sequence is determined by the dispatch controller and the above-mentioned process of selecting the particular subset of electrical cars eligible for charging based on the revised charging sequence is repeated so as to determine a new subset of electrical cars. In this manner, a dynamic revision mechanism is imposed to the composition of the subset of electrical cars to be charged. This dynamic revision mechanism operates to ensure that the electrical cars with the most urgent need for charging (to comply with the target state of charge at the target time) are identified at the regular time intervals and appropriately charged.

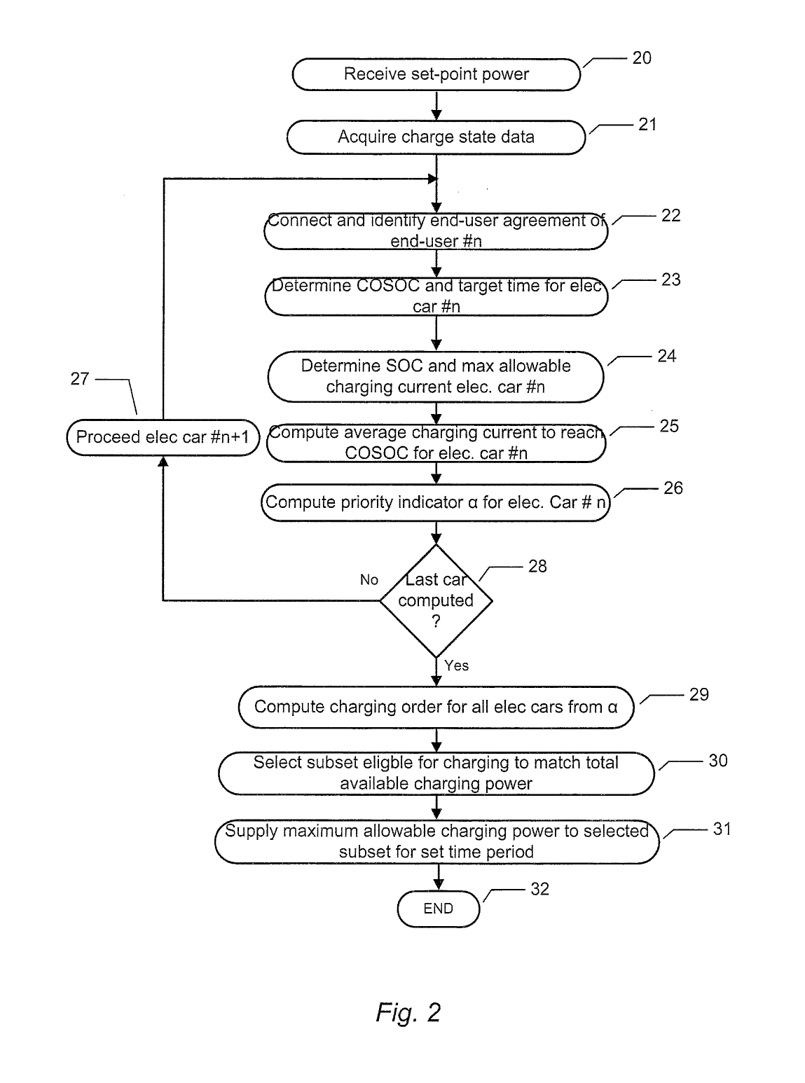

FIG. 2 is a flowchart of the operation of the dispatch controller 14 of the distributed electrical power system 1. The dispatch controller is preferably implemented as application program running on a central computer which may comprise a PC based or UNIX based server. A SCADA system is a preferable computing platform for the present dispatch controller embodiment. The SCADA system may comprise proprietary or commercial solutions such as e.g. WinCC, RSLogix 5000, etc.

In step 20, the dispatch controller receives a set-point power from an energy aggregator or distribution system operator. A total available charging power for dispatch and distribution by the dispatch controller to the electrical cars, and possibly other rechargeable power units, is indicated by this set-point power applied to an input of the dispatch controller

In step 21, the dispatch controller acquires, via the WLAN link, charge state data from the connected electrical cars and possibly other rechargeable power units indicating their respective current states of charge (SOCs).

In steps 22 and 23, the dispatch controller connects to the customer or end-user data base and retrieves information about the contractual obligations associated with a particular end-user, i.e. end-user #n, based on an end-user ID, in terms of the target state of charge and the target time for the end-user' electrical car.

In step 24, the dispatch controller holds the already acquired (in step 21) information regarding the current state of charge of the end-user's electrical car and additionally retrieves a maximum allowable charging current for the end-user's electrical car from the customer or end-user data base.

In step 25, the dispatch controller computes or determines a numerical priority indicator value for the electrical car of end-user #n so as to conveniently rank the charging order of the electrical cars according to their need for charging power. The dispatch controller computes an average charging current required to reach the target state of charge at the target time for the electrical car of end-user #n based on the current state of charge information acquired in step 21 and the maximum allowable charging current information acquired in step 24.

In step 26, the dispatch controller divides the computed average charging current with the already known value of the maximum allowable charging current to determine and store (for later ranking purposes in step 29) a value of the priority indicator, a, for the electrical car of end-user #n. In step, 28, the dispatch controller determines whether the computation process has been completed for all electrical cars connected to the dispatch controller. If not, the dispatch controller proceeds to the next electrical car #n+1 (or other rechargeable power units) and repeats steps 22-26 so as to compute respective the priority indicator values for all connected electrical cars before proceeding to step 29.

In step 29, the dispatch controller sets a charging sequence or order of the electrical cars directly according to magnitudes of the computed priority indicators, a such that the electrical car (or other rechargeable power unit) with the largest priority indicator value, for example 1.0 or 0.95, is number 1 in the computed charging sequence and the electrical car with smallest priority indicator, for example 0.05 or 0.1, is last and so on.

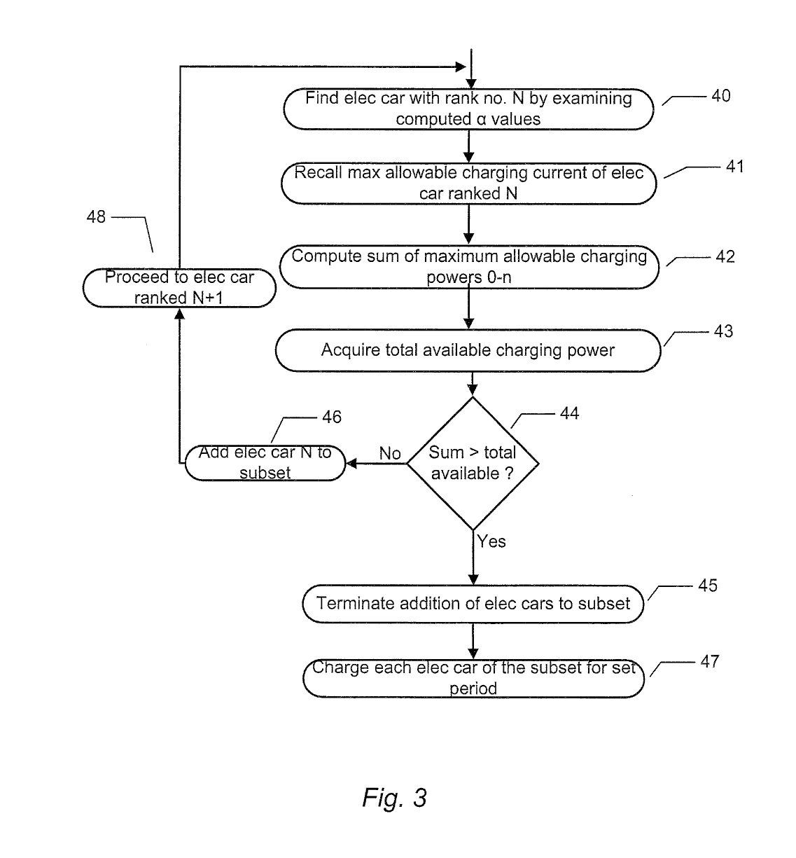

In step 30, the dispatch controller selects a subset of the electrical cars (or other rechargeable power units) eligible for charging based on the total available charging power, as indicated by the set-point power, by a routine of incrementally adding new electrical cars to the subset as will be explained in additional detail below with reference to FIG. 3.

In step 31, the dispatch controller sets the charging power to each car of the selected subset of the electrical car to its maximum allowable charging power. This charging state is maintained by the dispatch controller for a set or predetermined time interval, or cycle, such as a time interval between 5 minutes and 45 minutes. Thereafter, the dispatch controller preferably re-computes the charge priority for each of the electrical cars based on updated information about the current states of charge of the electrical vehicles as explained above.

FIG. 3 is a detailed flowchart of a selection routine executed by the dispatch controller in connection with step 30 of FIG. 2 to select a subset of rechargeable electrical cars eligible for charging based on the total available charging power, as indicated by the set-point power.

In step 40, the dispatch controller examines or parses the already computed magnitudes of the priority indicators to find the electrical car (or other rechargeable power unit) ranked as number 1 in the charging sequence. In steps 41 and 42, dispatch controller retrieves the already computed maximum allowable charging current for the electrical car ranked as number 1 and stores this value in register or other memory location storing an accumulated sum of charging power.

In step 43, the dispatch controller sets the total available charging power to be substantially identical to the set-point power.

In step 44, the dispatch controller compares the accumulated sum of charging power to the total available charging power. If the latter is smaller than the accumulated sum of charging power, the dispatch controller proceeds to step 46. In step 46, the electrical car ranked as number 1 is added to the subset of rechargeable electrical cars eligible for charging. The process thereafter proceeds to step 48 wherein the next electrical car (N+1) with rank 2 of the charging sequence is processed and possibly added to the subset eligible for charging and so on until the comparison in step 44 results in a yes (Y) because the accumulated sum of charging power exceeds the total available charging power. Under this condition, the dispatch controller proceeds to step 45 and terminates further examination of the electrical cars in the charging sequence in step 45. At this point, the size of the subset eligible for charging is fixed (at least until charging priorities are recomputed) and the individual electrical cars of the subset are known.

In step 47, the dispatch controller controls each of the individual electrical cars of the subset to charge at its maximum allowable charging power for the set period of time by transmitting an appropriate charge control input to the steerable charge control systems of the electrical cars via the WLAN link. The residual electrical cars are preferably left uncharged or with negligible charging current for the set period of time in the present embodiment of the invention.

1. A distributed electrical power system comprising:
a plurality of rechargeable power units coupled to a common electrical power grid at remote locations,
a dispatch controller configured to set a total charging power to the plurality of rechargeable power units based on a set-point power from an energy aggregator;
the dispatch controller being configured to:
acquire charge state data from the plurality of individual rechargeable power units indicating their respective current states of charge through a data communication link,
determine a target state of charge at a target time for each of the plurality of rechargeable power units based on an end-user agreement associated with an individual or a set of rechargeable power units,
determine charging current characteristics of each of the plurality of rechargeable power units,
compute a charge priority for each rechargeable power unit indicative of an amount of time required to reach the target state of charge based on the current state of charge, the target state of charge, the target time and the charging current characteristics of the rechargeable power unit,
determine a charging sequence or order of supplying charging power to the plurality of rechargeable power units based on computed charge priorities.

2. A distributed electrical power system according to claim 1, wherein the dispatch controller is configured to:
determine a maximum allowable charging current of each of the rechargeable power units,
estimate a minimum time interval required for reaching the target state of charge for each of the plurality of rechargeable power units,
organize the charging sequence according to the determined minimum time intervals such that the rechargeable power unit with the shortest minimum time interval is placed first in the charging sequence and the rechargeable power unit with the longest minimum time interval placed last.

3. A distributed electrical power system according to claim 1, wherein the dispatch controller is configured to:
determine a priority indicator (a) for each rechargeable power unit by computing an average charging current required to reach the target state of charge at the target time,
divide the computed average charging current with a maximum allowable charging current of the rechargeable power unit,
supply charging power to the plurality of rechargeable power units according to the order indicated by computed values of the priority indicators.

4. A distributed electrical power system according to claim 2, wherein the dispatch controller is configured to:
select a subset of rechargeable power units with highest charge priorities such that a sum of the respective maximum allowable charging powers of the subset matches the set-point power,
simultaneously charge each rechargeable power unit of the subset with its maximum allowable charging power for a predetermined time interval.

5. A distributed electrical power system according to claim 1, wherein the dispatch controller is configured to:
re-compute the charge priority for each rechargeable power unit at regular or non-regular time intervals such as time intervals smaller than 30 minutes, more preferably smaller than 15 minutes, or even more preferably smaller than 5 minutes; and
charge the plurality of rechargeable power units in accordance with the re-computed sequence or order.

6. A distributed electrical power system according to claim 1, wherein the target state of charge of each of the rechargeable power units is set to a value larger than 60% of a maximum charge storage capacity of the rechargeable power unit.

7. A distributed electrical power system according to claim 6, wherein the target state of charge of each of the rechargeable power units is set to a value between 65% and 95% of the maximum charge storage capacity of the rechargeable power unit.

8. A distributed electrical power system according to claim 1, wherein one or more of the plurality of rechargeable power units comprise(s) electrical vehicles.

9. A distributed electrical power system according to claim 1, wherein each of the plurality of rechargeable power units comprises a steerable charge control system configured to control charging power to the rechargeable power unit in accordance with a charge control input supplied by the dispatch controller through the data communication link.

10. A distributed electrical power system according to claim 9, wherein the steerable charge control system of each rechargeable power unit is adapted to transmit the maximum allowable charging power of the rechargeable power unit to the dispatch controller.

11. A distributed electrical power system according to claim 9, wherein the steerable charge control system of each rechargeable power unit is adapted to:
compute a minimum time period required to reach the target state of charge at the target time,
override the charge control input and set a predetermined charging power to the rechargeable power unit if the computed minimum time period exceeds actual time left to the target time.

12. A distributed electrical power system according to claim 11, wherein the steerable charge control system is adapted to:
compute a minimum time period required to reach the target state of charge at the target time,
prepare and transmit an electronic alert message to an end-user if the computed minimum time period exceeds actual time left to the target time.

13. A distributed electrical power system according to claim 11, wherein the steerable charge control system of the rechargeable power unit comprises a two quadrant or a four quadrant power converter operatively coupled to the common electrical power grid so as to supply charging power from the common electrical power grid to the rechargeable power unit or supply electrical power from the rechargeable power unit to the common electrical power grid.

14. A distributed electrical power system according to claim 13, wherein the dispatch controller is configured to:
identify a first subset of rechargeable power units having respective current states of charge above the target states of charge,
identify a second subset of rechargeable power units having respective current states of charge below the target states of charge,
command, through the steerable charge control systems, the first subset of rechargeable power units to supply a predetermined amount of electrical power to the common electrical power grid,
command, through the steerable charge control systems, the second subset of rechargeable power units to partly or entirely consume the predetermined amount of electrical power from the common electrical power grid.

15. A distributed electrical power system according to claim 1, comprising a customer database operatively coupled to the dispatch controller,
wherein said customer database comprises the charging current characteristics, the target state of charge and the target time for each of the plurality of rechargeable power units.

16. A distributed electrical power system according to claim 15, wherein the customer database, for each rechargeable power unit, comprises one or more end-user information items selected from the group consisting of end-user identity and address, preferred charging times, historic charging times, utility supplier identifier, and rechargeable power unit identifier.

17. A distributed electrical power system according to claim 1, wherein one or more of the rechargeable power units comprises an aggregated pool of separate and proximately located rechargeable power units.

18. A method of controlling supply of electrical power to a plurality of rechargeable power units coupled to a common electrical power grid at remote locations, the method comprising steps of:
a) receiving a set-point power from an energy aggregator,
b) acquiring charge state data from the plurality of rechargeable power units about their respective current states of charge through a data communication link,
c) determining a target state of charge at a target time for each of the plurality rechargeable power units based on an end-user agreement associated with an individual or a set of rechargeable power units,
d) determining charging current characteristics of each of the plurality of rechargeable power units,
e) computing a charge priority for each rechargeable power unit indicative of the amount of time required to reach the target state of charge based on the current state of charge, the target state of charge, the target time and the charging current characteristics of the rechargeable power unit,
f) determining a sequence or order of supplying charging power to the plurality of rechargeable power units based on computed charge priorities, and
g) controlling charging of the plurality of rechargeable power units in accordance with the determined sequence or order.

19. A method according to claim 18, wherein steps a) to g) are performed by a dispatch controller, wherein the dispatch controller is configured to:
determine a maximum allowable charging current of each of the rechargeable power units,
estimating a minimum time interval required for reaching the target state of charge for each of the plurality of rechargeable power units,
organizing the charging sequence according to the determined minimum time intervals.

20. A method according to claim 18, wherein steps a) to g) are performed by a dispatch controller, wherein the dispatch controller is configured to:
determine a priority indicator (a) for each rechargeable power unit by computing an average charging current required for the rechargeable power unit to reach the target state of charge at the target time,
divide the computed average charging current value with a maximum allowable charging current of the rechargeable power unit, and
supply charging current to the plurality of rechargeable power units in accordance with the determined priority indicators such that rechargeable power units with large priority indicators are charged before rechargeable power units with small priority indicators.

21. A method according to claim 19, wherein the dispatch controller is configured to:
select a subset of rechargeable power units with highest charge priorities such that a sum of the respective maximum allowable charging powers of the subset matches the set-point power,
simultaneously charge each rechargeable power unit of the subset with its maximum allowable charging power.

22. A method according to claim 18, wherein the charge priority according to step e) is recomputed at regular or non-regular time intervals; the method further comprising charging of the plurality of rechargeable power units in accordance with the re-computed sequence or order.

23. A method according to claim 18 wherein the target state of charge of each of the rechargeable power units is set to a value between 65% and 95% of a maximum charge storage capacity of the rechargeable power unit.

24. A method according to claim 18, wherein each of the plurality of rechargeable power units comprises a steerable charge control system; and wherein the steerable charge control system supplies charging power to the rechargeable power unit in accordance with a charge control input supplied by the dispatch controller through the data communication link.

25. A computer-implemented dispatch controller comprising a program memory loaded with a set of program instructions configured to execute steps a)-g) of claim 18.

26. A data carrier comprising a set of program instructions according to claim 25.

27. A data carrier according to claim 26, wherein the set of program instructions comprises executable microprocessor code for a Digital Signal Processor.
